(19) United States
(12) Patent Application Publication
(10) Pub. No.: US 2023/0254544 A1
(43) Pub. Date: Aug. 10, 2023

(54) COMPUTER PROGRAM AND SERVER

(71) Applicant: 17LIVE Japan Inc., Tokyo (JP)

(72) Inventor: Nagisa TASHIRO, Tokyo (JP)

(21) Appl. No.: 17/946,405

(22) Filed: Sep. 16, 2022

(30) Foreign Application Priority Data
Feb. 8, 2022 (JP) 2022-017620

(51) Int. Cl. H04N 21/482; H04N 21/478

(52) U.S. Cl. CPC H04N 21/482; H04N 21/478

(57) ABSTRACT

The present disclosure provides a live streaming technology conducive good fortune-telling experience. A computer program, dedicated to offering good fortune-telling experience by live streams, is provided to enable a user terminal at a playing end for live streaming related video data to achieve the functions of: receiving video data from a server via a network; displaying a plurality of items about fortune-telling on a screen of the user terminal at the playing end; receiving an item, with the item being one of the plurality of items and being selected by a user at the playing end; and obtaining, during a live stream, a fortune-telling result entered by a user at a generating end, with the user having been presented with an information corresponding to the selected item.

### CROSS-REFERENCE TO RELATED APPLICATIONS

This application is based on and claims the benefit of priority from Japanese Patent Application Serial No. 2022-017620 (filed on Feb. 8, 2022), the contents of which are hereby incorporated by reference in its entirety.

### TECHNICAL FIELD

The present disclosure relates to a computer program and a server.

### BACKGROUND

Owing to IT technological advancements, the way in which information exchange takes place is evolving. In the 20th century, one-way information communication occurred in the form of newspapers and later by television. Over the past thirty years or so, not only were cellular phones and computers popularized, but the communication speed of the Internet also increased greatly, resulting in the rise of real-time, two-way communication services, such as online chat service. Reduction in storage cost enables the popularization of video-on-demand (VOD) video broadcast service. Since 2019, video-based, real-time communication services, especially live streaming service, have been all the rage because of the robustness of smartphones and high network speed typical of 5G. Live streaming service entertains participants from around the world and at a young age increasing with time.

So far fortune-telling has been a service provided face-to-face. A fortune-teller and a client sit face-to-face. The fortune-teller performs fortune-telling while talking to the client. For example, non-patent document 1 discloses performing the aforesaid fortune-telling by live streaming. Owing to the recent COVID-19 pandemic, the demand for fortune-telling live streaming and viewing is on the rise.

### DOCUMENTS PERTAINING TO PRIOR ART

Two non-patent documents pertaining to the prior art are as follows:
Non-patent document 1: Trial run of CAVE's face-to-face fortune-telling live streaming service (Sensen) on March 15, CAVE Corporation. https://prtimes.jp/main/html/rd/p/000000928.000001290.html
Non-patent document 2: Liver Army, 17LIVE. https://helpfeel.com/17media-jp/%E3%83%A9%E3%82%A4%E3%83%90%E3%83%BC%E3%82%A2%E3%83% BC%E3%83%9F%E3%83%BC-5d1b19ed60a44d0017857bf6

### SUMMARY

A conversation with a client is an essential factor in fortune-telling, as the conversation is highly compatible with a live stream which enables two-way communication between a live streamer and a viewer; thus, there is great potential for growth in the demand for fortune-telling live streams. However, conventional functions of live streams fail to provide good fortune-telling experience.

In view of the aforesaid drawback of the prior art, it is an objective of the disclosure to provide a live streaming technology conducive good fortune-telling experience.

An aspect of the disclosure provides a computer program. The computer program is adapted to enable a user terminal at a playing end for live streaming related video data to achieve functions of: receiving video data from a server via a network; displaying a plurality of items about fortune-telling on a screen of the user terminal at the playing end; receiving an item, with the item being one of the plurality of items and being selected by a user at the playing end; and obtaining, during a live stream, a fortune-telling result entered by a user at a generating end, wherein the user enters the fortune-telling result after being presented with an information corresponding to the selected item.

Another aspect of the disclosure provides a computer program. The computer program is adapted to enable a user terminal at a generating end for live streaming related video data to achieve functions of: sending video data to a server via a network; displaying on a screen of the user terminal at the generating end an information corresponding to an item, with the item being one of a plurality of items about fortune-telling and being selected by a user at a playing end; and receiving a fortune-telling result entered by a user at the generating end, wherein the user enters the fortune-telling result after being presented with the information.

A further aspect of the disclosure provides a server. The server comprises: a means for transmitting the video data from a user terminal at a generating end for live streaming related video data to a user terminal at a playing end; a means for receiving from the user terminal at the playing end a recognition information about an item, with the item being one of a plurality of fortune-telling-related items displayed on the screen of the user terminal at the playing end and being selected by a user at the playing end; a means for identifying, according to the received recognition information, an information corresponding to the selected item; a means for sending the selected information to the user terminal at the generating end; a means for receiving, from the user terminal at the generating end, a fortune-telling result entered by a user at the generating end, wherein the user at the generating end enters the fortune-telling result after being presented with the selected information; and a means for providing the received fortune-telling result to the user terminal at the playing end.

Equivalent aspects of the disclosure include combinations of the aforesaid constituent elements of the disclosure or mutual replacements of the aforesaid constituent elements of the disclosure between devices, methods, systems, computer programs, and recording media for storing computer programs.

### Effect of Invention

According to the disclosure, good fortune-telling experience is attained by live streaming.

### BRIEF DESCRIPTION OF THE DRAWINGS

FIG. 1 is a schematic view of a live streaming system according to an embodiment of the disclosure.

FIG. 2 is a block diagram of an information processing device according to an embodiment of the disclosure.

FIG. 3 is a block diagram of a user terminal shown in FIG. 1.

FIG. 4 is a block diagram of a server shown in FIG. 1.

FIG. 5 is a table of data structure of an example of a streaming database shown in FIG. 4.

FIG. 6 is a table of data structure of an example of a user database shown in FIG. 4.

FIG. 7 is a table of data structure of an example of a schedule database shown in FIG. 4.

FIG. 8 is a table of data structure of an example of a gift database shown in FIG. 4.

FIG. 9 is a table of data structure of an example of a customization database shown in FIG. 4.

FIG. 10 is a table of data structure of an example of a fortune-telling record database shown in FIG. 4.

FIG. 11 is a flowchart of the process of a private tarot fortune-telling broadcast in the live streaming system.

FIG. 12 is a schematic view of a broadcast schedule entering frame typically displayed on the screen of a live streamer's user terminal.

FIG. 13 is a schematic view of a broadcast schedule notification frame typically displayed on the screen of a follower's user terminal.

FIG. 14 is a schematic view of the broadcast schedule notification frame typically displayed on the screen of the follower's user terminal.

FIG. 15 is a schematic view of a live streaming frame typically displayed on the screen of a viewer user terminal.

FIG. 16 is a flowchart of the process of creating calendar information in the server.

FIG. 17 is a schematic view of a calendar display frame typically displayed on the screen of a user terminal which requests sending calendar information.

FIG. 18 is a schematic view of a broadcast reminder frame typically displayed on the screen of the live streamer's user terminal.

FIG. 19 is a flowchart of the process of the private tarot fortune-telling broadcast.

FIG. 20 is a schematic view of a broadcast end live streaming frame typically displayed on the screen of the live streamer's user terminal.

FIG. 21 is a schematic view of a card selection frame typically displayed on the screens of the viewer user terminals.

FIG. 22 is a schematic view of a selection result frame typically displayed on the screens of the viewer user terminals.

FIG. 23 is a schematic view of a fortune-telling result selection frame typically displayed on the screen of the live streamer's user terminal.

FIG. 24 is a schematic view of a fortune-telling result description frame typically displayed on the screens of the viewer user terminals.

FIG. 25 is a schematic view of a fortune-telling record frame typically displayed on the screens of the viewer user terminals.

FIG. 26 is a schematic view of a card selection frame typically displayed on the screens of the viewer user terminals during an all-viewers tarot fortune-telling broadcast according to a variant embodiment of the disclosure.

FIG. 27 is a schematic view of a fortune-telling result display frame typically displayed on the screens of the viewer user terminals.

### DETAILED DESCRIPTION OF THE EMBODIMENTS

Identical or equivalent constituent elements, components, processes, and signals shown in the drawings are denoted by identical reference numerals and reference signs, and related descriptions do not repeat. Some unimportant components disclosed hereunder are omitted from the drawings.

In an embodiment of this disclosure, the live streaming system provides a mechanism whereby a fortune-telling live streamer carries out a fortune-telling live stream smoothly and effectively, rendering fortune-telling live streaming fashionable and popular.

Another embodiment of this disclosure provides a function for confirming viewer fortune-telling result records. A drawback of conventional live streaming is that, basically, the contents of a broadcast leave no record. As a result, the prior art offers no remedy for viewers' forgetting fortune-telling contents after a fortune-telling live stream. In view of this, this embodiment provides a mechanism whereby fortune-telling results in a fortune-telling live stream are regarded as data and thus stored; hence, viewers can refer to related records to thereby recall fortune-telling contents otherwise forgotten.

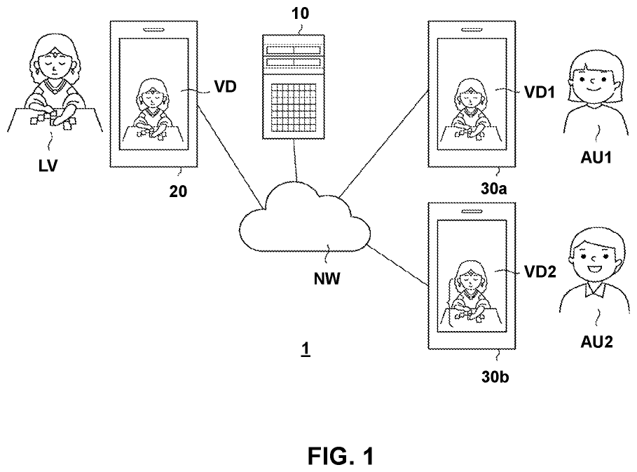

FIG. 1 is a schematic view of a live streaming system 1 according to an embodiment of the disclosure. The live streaming system 1 provides a two-way live stream service conducive to real-time communication between a live streamer (also known as liver and streamer) LV and viewers AU (including viewer AU1, viewer AU2 . . . ) As shown in FIG. 1, the live streaming system 1 comprises a server 10, a user terminal 20 at the live streamer end, and user terminals 30 (including user terminal 30a, user terminal 30b . . . ) at the viewer end. The live streamer and the viewers are also collectively known as users. The server 10 comprises one or more information processing devices connected to a network NW. The user terminals 20, 30 are mobile terminals, such as smartphones, tablets, laptops, recorders, mobile game consoles, and wearable devices, or stationary devices, such as desktops. The server 10, user terminal 20 and user terminals 30 are connected by various networks NW, whether wired or wireless, and thus can communicate with each other.

In the live streaming system 1, the live streamer LV, the viewers AU and an administrator (not shown) which manages the server 10 are participants. The live streamer LV records audios and videos about his or her songs, comments, performance, fortune-telling, and video game live streaming with the user terminal 20 and then directly uploads the recorded audios and videos to the server 10, in real time. In this embodiment, the live streamer LV provides fortune-telling service to the viewers AU by live streaming. The live streamer LV is or is not a fortune-teller. The administrator provides a platform disposed in the server 10 and adapted for use in a live stream and mediates or manages real-time communication between the live streamer LV and the viewers AU. At the user terminals 30, the viewers AU access the platform to select and watch expected contents. During the live stream, the viewers AU express support, for example, by leaving messages, at the user terminals 30, whereas the live streamer LV, who provides the contents, gives a response to the messages or related support, such that the response is transmitted to the viewers AU in the form of a video and/or audio to enable two-way communication.

The term “live streaming” used herein means a data transmission mode whereby “contents of audios and videos recorded at the user terminal 20 of the live streamer LV are played and viewed at the user terminals 30 the viewers AU substantially in real time.” The term “live stream” used herein means a broadcast implemented by the data transmission mode. The live stream is implemented by existing live stream technologies, such as HTTP Live Streaming, Common Media Application Format, Web Real-Time Communications, Real-Time Messaging Protocol, and MPEG DASH. In the data transmission mode of the live stream, the recording of contents by the live streamer LV and the viewing of the contents by the viewers AU with an established delay occur simultaneously. The delay is short enough to enable communication between the live streamer LV and the viewers AU. However, the live stream is different from a VOD broadcast. The VOD broadcast entails storing the entire data of the recorded contents in a server and then fetching the data from the server at a user's request at any point in time to provide the data to the user.

The “video data” disclosed herein includes image data (also known as video data) generated by the picture-taking function of the user terminals 20, 30 and audio data (also known as voice data) generated by the audio input function of the user terminals 20, 30. The video data is played at the user terminals 20, 30, and thus the users view its contents. In this embodiment, during the time period following the generation of the video data at the live streamer's user terminal but preceding the playing of the generated video data at the viewers' user terminals, the video data has its form, size and format changed by undergoing processes of compression, extension, encoding, decoding, and translation. Despite the processes, the contents (for example, dynamic image or audio) of the video data remain unchanged substantially. Thus, in this embodiment, the video data which has undergone the processes is regarded as identical to the video data which has not yet undergone the processes for the sake of illustration. Thus, in the situation where the video data is generated at the live streamer's user terminal and then played at the viewers' user terminals via the server 10, the video data generated at the live streamer's user terminal, the video data played via the server 10, and the video data received and played at the viewers' user terminals are identical.

In the example illustrated by FIG. 1, the live streamer LV carries out a fortune-telling live stream. The image and audio of the live streamer LV carrying out the fortune-telling live stream are recorded at the user terminal 20 of the live streamer LV to generate video data, and then the video data is sent to the server 10 via a network NW. The user terminal 20 presents the recorded dynamic image VD of the live streamer LV on the screen of the user terminal 20, so as to confirm the contents broadcast by the live streamer LV.

The user terminals 30a, 30b of the viewers AU1, AU2 who access the platform to request viewing the live stream of the live streamer LV receive the video data of the live stream via a network NW, respectively, play the received video data, display dynamic images VD1, VD2 on the screens, and output audio from the loudspeaker. The dynamic images VD1, VD2 displayed on the user terminals 30a, 30b are substantially identical to the dynamic image VD whose picture is taken of by the user terminal 20 of the live streamer LV. The audios outputted by the user terminals 30a, 30b are substantially identical to the audios recorded by the user terminal 20 of the live streamer LV.

The audio-recording and video-shooting at the user terminal 20 of the live streamer LV and the playing of video data at the user terminals 30a, 30b of the viewers AU1, AU2 occurs substantially simultaneously. If the viewer AU1 leaves a message at the user terminal 30a in response to the fortune-telling contents of the live streamer LV, the server 10 will display the message at the user terminal 20 of the live streamer LV and the user terminals 30a, 30b of the viewers AU1, AU2 in real time. After reading the message, the live streamer LV begins to comment on its contents. The dynamic images and audios of the comments are outputted from the user terminals 30a, 30b of the viewers AU1, AU2, signaling the commencement of a dialogue between the live streamer LV and the viewer AU1. Therefore, live streams carried out with the live streaming system 1 achieve two-way communication.

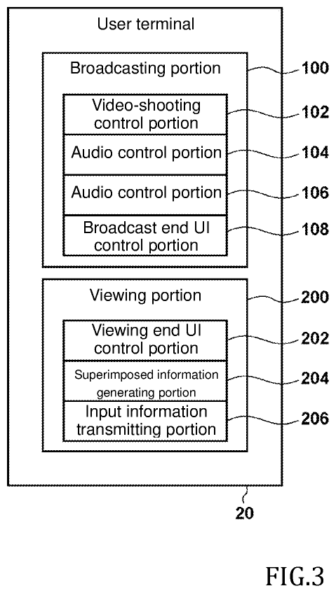

FIG. 3 is a block diagram of the user terminal 20 shown in FIG. 1. The user terminals 30 have the same function and structure as the user terminal 20. All the elements shown in FIG. 3 and any subsequent block diagram can be implemented jointly by a computer CPU and the like from a hardware perspective and by a computer program from a software perspective. Therefore, persons skilled in the art are able to understand that all the elements shown in FIG. 3 can be implemented in various ways by a combination of hardware and software.

The live streamer LV and viewers AU download a live stream application (hereinafter referred to as the live stream APP) of this embodiment to the user terminals 20, 30 from an application market via the network NW and install it. Alternatively, the live stream APP is installed on the user terminals 20, 30 in advance. The user terminals 20, 30 execute the live stream APP and thereby communicate with the server 10 via the network NW to perform various functions. The description is hereinafter based on regarding the functions implemented by the execution of the live stream APP by (processors, such as CPUs, of) the user terminals 20, 30 as the functions of the user terminals 20, 30. The functions are actually performed on the user terminals 20, 30 by the live stream APP. In another embodiment, the functions are implemented with a computer program written in a programming language, such as HTML (Hyper Text Markup Language), sent from the server 10 to a browser of the user terminals 20, 30 via the network NW, and executed by the browser.

The user terminal 20 comprises a broadcasting portion 100 and a reception portion 200. The broadcasting portion 100 generates video data about a user's images and voices (i.e., audios) and provides the video data to the server 10. The reception portion 200 fetches the video data from the server 10 and plays the video data. The users starts the broadcasting portion 100 to begin a broadcast. The user starts the reception portion 200 to watch the video thus played. When the broadcasting portion 100 starts, the user terminal is the live streamer end, i.e., a generating end for the video data. When the reception portion 200 starts, the user terminal is the viewer end, i.e., a playing end for the video data.

The broadcasting portion 100 comprises a video-shooting control portion 102, audio control portion 104, video transmitting portion 106 and broadcast end UI control portion 108. The video-shooting control portion 102 is connected to a camera not shown in FIG. 3 to control the camera to take pictures. The video-shooting control portion 102 fetches image data from the camera. The audio control portion 104 is connected to a microphone not shown in FIG. 3 to control audio input from the microphone. The audio control portion 104 fetches audio data from the microphone. The video transmitting portion 106 sends the video data including image data fetched from the video-shooting control portion 102 and audio data fetched from the audio control portion 104 to the server 10 via the network NW. The video transmitting portion 106 sends video data in real time. Thus, the “generation of video data by the video-shooting control portion 102 and audio control portion 104” and the “transmission of the generated video data by the video transmitting portion 106” occur substantially simultaneously. The broadcast end UI control portion 108 controls interfaces (UI) facing the live streamer. The broadcast end UI control portion 108 is connected to a screen not shown in FIG. 3 and plays video data (sent by the video transmitting portion 106) to thereby display dynamic images on the screen. The broadcast end UI control portion 108 displays on the screen items for use in operation and items for use in receiving instructions, so as to receive click input from the live streamer.

The reception portion 200 comprises a viewing end UI control portion 202, superimposed information generating portion 204 and input information transmitting portion 206. The reception portion 200 receives the video data of the live stream from the server 10 via the network NW. The viewing end UI control portion 202 controls the UI facing the viewers. The viewing end UI control portion 202 is connected to a screen not shown in FIG. 3 and a loudspeaker not shown in FIG. 3 to play the received video data, display dynamic images on the screen, and output audios from the loudspeaker. Outputting images from the screen and outputting audios from the loudspeaker is collectively referred to as “playing video data.” The viewing end UI control portion 202 is connected to an input means not shown in FIG. 3, such as a touch panel, keyboard or screen. The input means fetches inputs from users. The superimposed information generating portion 204 enables an established frame image to be superimposed on the image of the video data fetched from the server 10. The frame image comprises various user interface items (hereinafter referred to as “items”) for receiving an input from the users, messages left by the viewers, and information fetched from the server 10. Inputs entered by the users and fetched by the viewing end UI control portion 202 are sent by the input information transmitting portion 206 to the server 10 via the network NW.

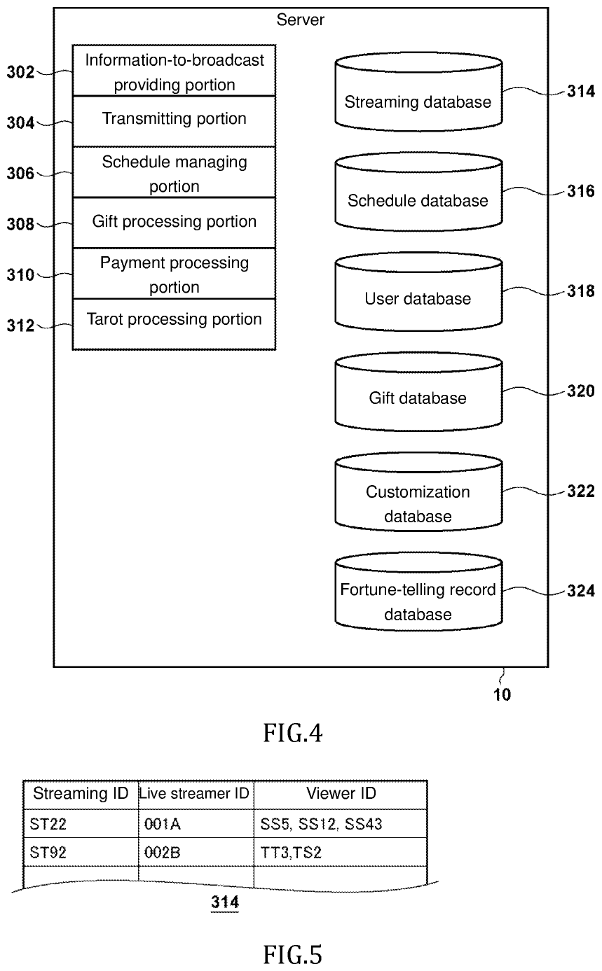

FIG. 4 is a block diagram of the server 10 shown in FIG. 1. The server 10 comprises an information-to-broadcast providing portion 302, transmitting portion 304, schedule managing portion 306, gift processing portion 308, payment processing portion 310, tarot processing portion 312, streaming database 314, schedule database 316, user database 318, gift database 320, customization database 322 and fortune-telling record database 324.

FIG. 5 is a table of data structure of an example of the streaming database 314 shown in FIG. 4. The streaming database 314 stores information about an ongoing live stream. The streaming ID for identifying a live stream, the live streamer's user ID for identifying a live streamer, i.e., live streamer ID, and the live stream viewer user ID for identifying a viewer, i.e., viewer ID, in the live stream platform provided by the live streaming system 1 are matched and stored in the streaming database 314. In this embodiment, in the live stream platform provided by the live streaming system 1, a user becomes a live streamer whenever the user starts a live stream, whereas users become viewers whenever they watch a live stream broadcast by another user. A live streamer's identity and a viewer's identity are variable, because a user may log in with a live streamer ID at a point in time but with a viewer ID at another point in time.

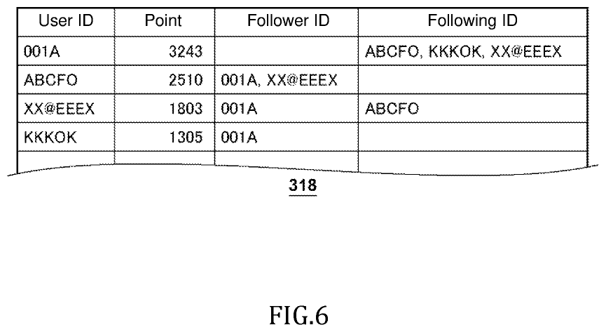

FIG. 6 is a table of data structure of an example of the user database 318 shown in FIG. 4. The user database 318 stores user-related information. The user database 318 matches and stores a user ID for identifying a user and points in his or her possession, a follower ID for identifying another user following the user, and a following ID for identifying yet another user whom the user follows. The points are electronic values or digital values in circulation in a live stream platform. If a viewer gives a gift to a live streamer during a live stream, the live streamer's points will increase only by the value corresponding to the gift. The points, for example, determine the amount of reward or money the live streamer can receive from an administrator of the live stream platform.

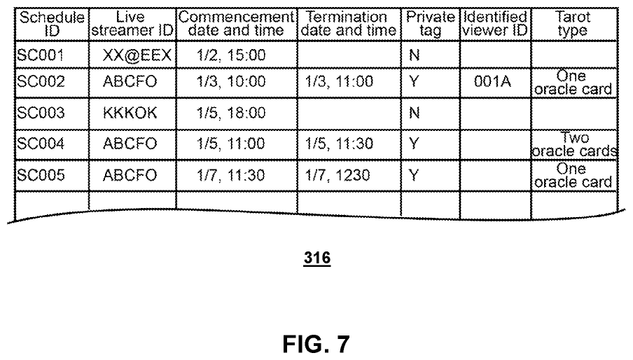

FIG. 7 is a table of data structure of an example of the schedule database 316 shown in FIG. 4. The schedule database 316 stores a predetermined live stream schedule. The schedule database 316 matches and stores a schedule ID for identifying a schedule, the live streamer ID of the live streamer carrying out a live stream on the schedule, predetermined commencement date and time and predetermined termination date and time of the live stream, a tag indicative of whether the live stream is a private broadcast, an identified viewer ID, and tarot types. This embodiment illustrates how the live streamer carries out a tarot fortune-telling live stream; however, persons skilled in the art understand that technical concepts disclosed in this embodiment are also applicable to fortune-telling live streams of any other types, such as astrology.

The private broadcast is a live stream whose participants are restricted to the live streamer and predetermined viewers. The private broadcast is implemented by prior art and thus is not described in detail herein. The private tag is “Y” and carries a schedule of an identified viewer ID, that is, a reserved live stream schedule whose participants are restricted to identified viewers identified with an identified viewer ID. For example, the schedule identified with the schedule ID “SC002” in the schedule database 316 of FIG. 7 is a live stream predetermined to be broadcast from 10:00 to 11:00, January 3, by the live streamer identified with the live streamer ID “ABCFO,” and it is a private broadcast schedule whose participants are restricted to identified viewers identified with identified viewer ID “001A.” In the live stream, the live streamer predetermines the tarot fortune-telling of one oracle card provided by identified viewers. The private tag is “Y” and does not carry a schedule of an identified viewer ID, that is, a private broadcast schedule which is currently available for reservations or can be reserved. For example, a schedule identified with the schedule ID “SC004” in the schedule database 316 of FIG. 7, and it is a private broadcast schedule related to tarot fortune-telling of two oracle cards and predetermined to be broadcast from 11:00 to 11:30, January 5, by the live streamer identified with the live streamer ID “ABCFO.” Since the identified viewer ID has not been registered, it is shown that the private broadcast is in the state of accepting participation reservation.

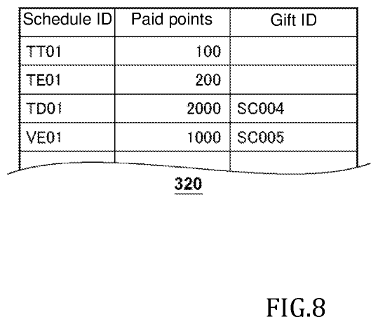

FIG. 8 is a table of data structure of an example of the gift database 320 shown in FIG. 4. The gift database 320 stores information about gifts available to viewers during a live stream. The gifts are electronic data defined by features as follows:
can be used to buy points or money as consideration or can be granted for free.
can be given to the live streamer by viewers; “giving gifts to the live streamer” is also known as “using gifts.”
buying gifts and using gifts occur in a paired, simultaneous manner; and, after buying gifts, viewers may use the gifts at any point in time.
if a viewer gives a gift to a live streamer, the live streamer will be granted points accordingly, resulting in an effect related to the gift as appropriate, for example, displaying a special effect corresponding to the gift on the live stream frame.

The gift database 320 matches and stores the gift ID for recognizing a gift, the points granted to the live streamer receiving the gift, i.e., the granted points, and the schedule ID of a schedule corresponding to the gift. The viewers may pay a consideration corresponding to the points granted for an anticipated gift while watching the live stream, thereby allowing the gift to be given to the live streamer. The payment of the consideration is carried out by an appropriate means for electronic billing; for example, the viewers pay the administrator the points corresponding to the granted points (such as the granted points per se, the points equal to the product of the granted points and an established coefficient, such as 1.2, or the points equal to the sum of the granted points and an established procedure points). Alternatively, the payment of the consideration is carried out by wire transfer and by credit.

A gift that matches a schedule ID is also known as a schedule gift. During a live stream, viewers can buy a playing frame of tarot fortune-telling of the live streamer and use it as a gift. If a viewer gives the schedule gift to the live streamer, the private broadcast between the live streamer and the viewer will be configured. The schedule gifts are presented as soon as the payment of the consideration and the private broadcast participation reservation occur simultaneously.

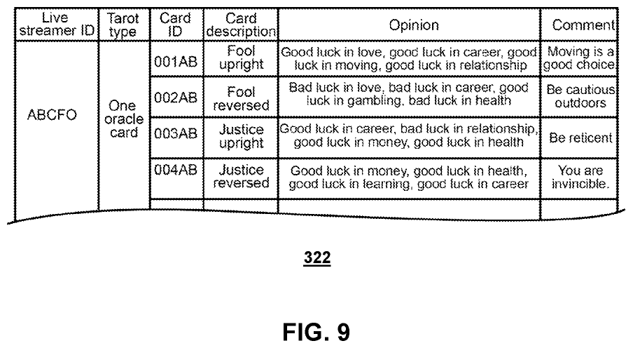

FIG. 9 is a table of data structure of an example of a customization database 322 shown in FIG. 4. The customization database 322 stores tarot fortune-telling contents about customization of the live streamers. The customization database 322 matches and stores the live streamer ID for recognizing the live streamer, tarot type, the card ID for recognizing a tarot card and its description, fortune-telling result options which viewers present to the live streamer when drawing the tarot card, and remarks. The contents of the customization database 322 are entered and updated by the live streamer. The live streamer accesses the customization database 322 of the server 10 through the user terminal 20 to read the tarot fortune-telling contents s/he entered. The live streamer appropriately updates and stores the entered contents. The user terminal 20 and the server 10 are structured to enable the live streamer to carry out the aforesaid operation. Each card ID in the customization database 322 carries multiple options; thus, the options vary with the card ID.

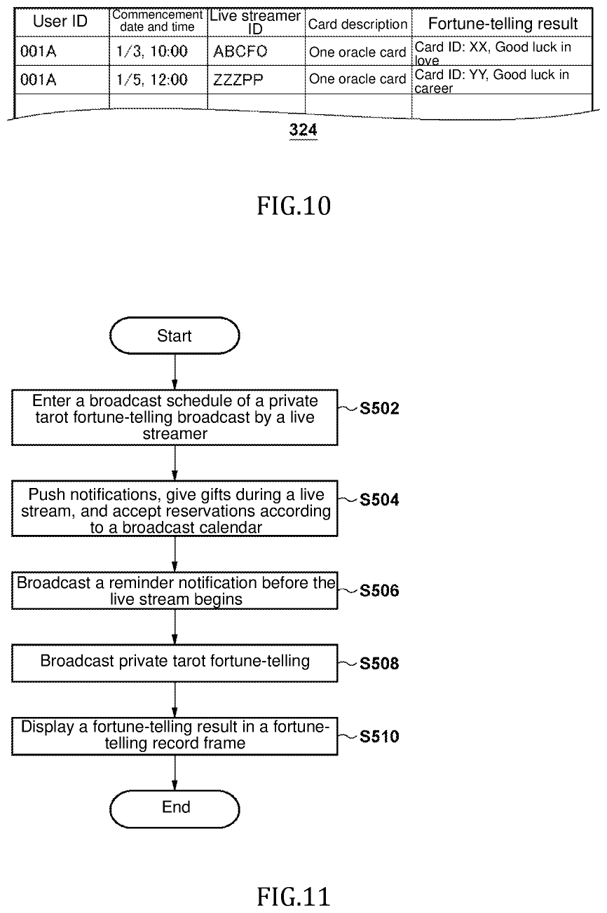

FIG. 10 is a table of data structure of an example of a fortune-telling record database 324 shown in FIG. 4. The fortune-telling record database 324 stores records of fortune-telling results entered and presented by the live streamer to viewers during a live stream of tarot fortune-telling. The fortune-telling record database 324 matches and stores the user ID of the viewers participating in a tarot fortune-telling live stream, the commencement time of the live stream, the live streamer ID of the live streamer of the live stream, the type of the tarot fortune-telling during the live stream, and a fortune-telling result. The fortune-telling result comprises the card ID of the tarot card presented for tarot fortune-telling and viewer fortunes corresponding thereto and inputted or selected by the live streamer.

Referring to FIG. 4, if the information-to-broadcast providing portion 302 receives a notice about commencement of a live stream from the user terminal 20 of the live streamer end via the network NW, the information-to-broadcast providing portion 302 will enter the streaming ID for recognizing the live stream and the live streamer ID of the live streamer of the live stream into the streaming database 314. If the information-to-broadcast providing portion 302 receives a request for a live stream-related information from the reception portion 200 of the user terminals 30 at the viewer end via the network NW, the information-to-broadcast providing portion 302 will refer to the streaming database 314 to generate a checklist of currently available live streams. The information-to-broadcast providing portion 302 sends the generated checklist to the request-making user terminals 30 via the network NW. The viewing end UI control portion 202 of the request-making user terminals 30 generates a live stream selection frame according to the received checklist and displays the live stream selection frame on the screens of the user terminals 30.

If the input information transmitting portion 206 of the user terminals 30 receives a live stream selection displayed in the live stream selection frame and selected by the viewers, the input information transmitting portion 206 of the user terminals 30 will generate a broadcast request including the streaming ID for identifying a live stream and send the broadcast request to the server 10 via the network NW. The information-to-broadcast providing portion 302 begins to provide the request-making user terminals 30 with a live stream identified with the streaming ID included in the received broadcast request. The information-to-broadcast providing portion 302 updates the streaming database 316 in such a way that the viewer ID of the streaming ID comprises the viewer ID of the viewers of the request-making user terminals 30.

During a live stream initiated by the information-to-broadcast providing portion 302, the transmitting portion 304 transmits video data from the user terminal 20 at the live streamer end to the user terminals 30 at the viewer end. The transmitting portion 304 receives a signal of displaying “the user input carried out by the viewers while the video data is being played” from the input information transmitting portion 206. The signal of displaying the user input is an item-identifying signal which shows the selected items displayed on the screens of the user terminals 30. The item-identifying signal comprises the viewer ID of the viewers, the live streamer ID of the live streamer performing the live stream being watched by the viewers, and the item ID of identified items. When an item is a gift, the item ID is the gift ID. Likewise, the transmitting portion 304 receives a signal (for example, an item-identifying signal) of “carrying out the user input by the live streamer while the video data is being played” from the broadcasting portion 100 of the user terminal 20.

The schedule managing portion 306 manages a live stream schedule in the live stream platform provided by the live streaming system 1. The schedule managing portion 306 communicates with the user terminal 20 of the live streamer to receive from the live streamer a request for entering a new live stream schedule or a request for changing/deleting an existing schedule. The schedule managing portion 306 updates the schedule database 316 according to the received new entering request or changing/deleting request. The schedule managing portion 306 simultaneously enters a new schedule and notifies the live streamer's followers.

The schedule managing portion 306 communicates with the viewers' user terminals 30 to thereby obtain a calendar information request of a live stream schedule from a request received by the viewers. The schedule managing portion 306 refers to the schedule database 316 to retrieve the required information and then provide the required information to the user terminals 30.

If the viewers enter an instruction on giving a schedule gift to the live streamer into the user terminals 30 while watching the live stream, an item-identifying signal including the “gift ID of a selected schedule gift” will be sent to the server 10 from the user terminals 30. The gift processing portion 308 refers to the gift database 320 to identify the schedule ID and the granted points corresponding to the schedule gift identified with the gift ID included in the item-identifying signal. The gift processing portion 308 updates the user database 318 by increasing the live streamer's points according to the granted points identified. For example, the gift processing portion 308 updates the user database 318 by adding the identified granted points to the points corresponding to the live streamer ID included in the item-identifying signal.

The gift processing portion 308 notifies the schedule managing portion 306 of the identified schedule ID. The schedule managing portion 306 updates the schedule database 316 by entering the viewer ID included in the item-identifying signal to become the identified viewer ID of the schedule identified with the schedule ID notified. Owing to the update, the viewers finish making reservations for the private broadcast. The gift processing portion 308 deletes from the gift database 320 the schedule gifts identified with the gift ID included in the item-identifying signal. In so doing, dual reservations are precluded.

The payment processing portion 310 processes schedule gift-related payments made by the viewers. The payment processing portion 310 updates the user database 318 by deducting consideration points for the schedule gifts identified with the gift ID included in the item-identifying signal from the viewer points identified with the viewer ID included in the item-identifying signal.

The function of the tarot processing portion 312 is described later.

The operation of the live streaming system 1 in accordance with the aforesaid technical features is described below.

FIG. 11 is a flowchart of the process of a private tarot fortune-telling broadcast in the live streaming system 1. To broadcast private tarot fortune-telling, the live streamer uses the user terminal 20 to access the server 10 and enter a broadcast schedule (S502). The schedule managing portion 306 enters a broadcast schedule received from the live streamer into the schedule database 316. The schedule managing portion 306 receives a push notification corresponding to the entered broadcast schedule, gifts at a live stream, and reservations made according to a broadcast calendar (S504). With the reservations being made and the broadcast commencement date and time being near, the schedule managing portion 306 sends a reminder notification to the live streamer's user terminal 20 and the viewers' user terminals 30 reserved (S506). The live streamer uses the user terminal 20 to start broadcasting the private tarot fortune-telling, and the viewers who have made reservations use the user terminals 30 to participate in the broadcast (S508). Upon completion of the broadcast and in the presence of a request from the viewers, the screens of the viewers' user terminals 30 which participated in the broadcast display a fortune-telling record frame including a fortune-telling result (S510).

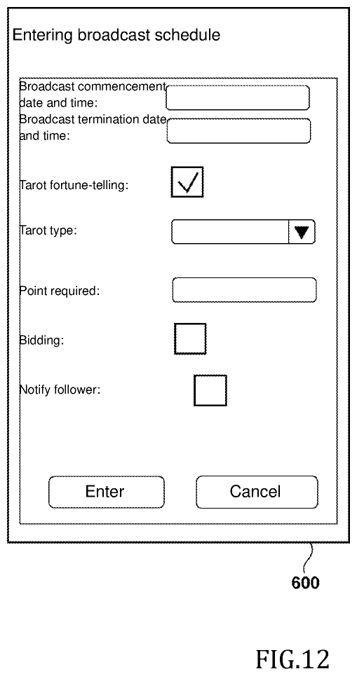

FIG. 12 is a schematic view of a broadcast schedule entering frame 600 typically displayed on the screen of a live streamer's user terminal 20 in step S502 illustrated by FIG. 11. The broadcast schedule entering frame 600 has: a region for receiving the input of broadcast predetermined commencement date and time, a region for receiving the input of broadcast predetermined termination date and time, a checkbox for specifying whether a broadcast is the private tarot fortune-telling broadcast, a region with a drop-down menu for receiving a choice of tarot fortune-telling type, a region for receiving point setting required to make a reservation for the broadcast, a checkbox for specifying whether a reservation becomes a bid, a checkbox for specifying whether to notify one's followers to register a schedule, register a button, and cancel a button together with broadcast schedule registration. The live streamer inputs necessary matters in the regions of the broadcast schedule entering frame 600 and clicks on the enter button. If the user terminal 20 detects a click on the enter button, the user terminal 20 will retrieve information inputted in the regions of the broadcast schedule entering frame 600. The user terminal 20 generates the schedule entering request signal including the retrieved information and sends the schedule entering request signal to the server 10 via the network NW. The schedule managing portion 306 enters a new broadcast schedule (hereinafter referred to as a private tarot fortune-telling broadcast schedule) into the schedule database 316 according to various informations included in the received schedule entering request signal.

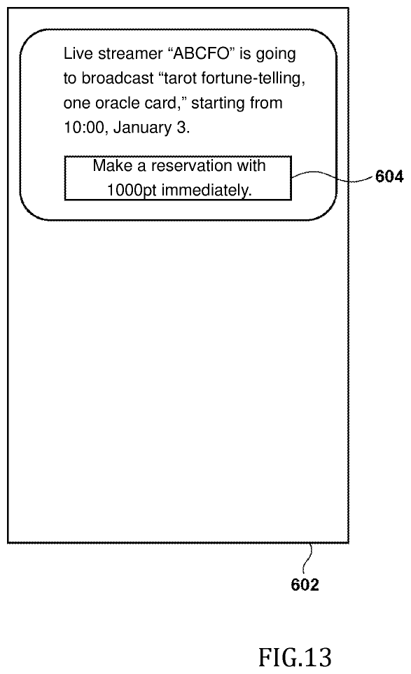

FIG. 13 is a schematic view of a broadcast schedule notification frame 602 typically displayed on the screen of a follower's user terminal 30 in step S504 illustrated by FIG. 11. The broadcast schedule notification frame 602 of FIG. 13 corresponds to the broadcast schedule entering frame 600 of FIG. 12. The live streamer selects the situation of “notifying followers” but does not select “bidding” and clicks on the enter button. In this situation, the schedule managing portion 306 refers to the user database 318 to identify “followers of the live streamer identified with the live streamer ID included in the received schedule entering request signal.” The schedule managing portion 306 notifies the user terminals 30 of identified followers of the private tarot fortune-telling broadcast schedule. The user terminals 30 display the broadcast schedule notification frame 602 on the screens according to the notification. The broadcast schedule notification frame 602 displays the entered points required for reservations, type of tarot fortune-telling, live streamer ID, and commencement date and time of the private tarot fortune-telling broadcast. The broadcast schedule notification frame 602 further displays a button 604 for receiving from followers the instructions for use in making reservations for the private tarot fortune-telling broadcast and the promise (consideration) to make payment. If the live streamer clicks on the button 604, the user terminals 30 will generate a reservation request signal including a follower's user ID and send the reservation request signal to the server 10 via the network NW.

The server which has received the reservation request signal carries out the processes as follows:

(1) The schedule managing portion 306 updates the schedule database 316 by entering the identified viewer ID of the private tarot fortune-telling broadcast schedule according to the user ID included in the received reservation request signal.

(2) The gift processing portion 308 updates the user database 318 by increasing the broadcasting live streamer's points according to the points required for making a reservation for the private tarot fortune-telling broadcast.

(3) The payment processing portion 310 updates the user database 318 by deducting the points required for making a reservation for the private tarot fortune-telling broadcast from the points of the users identified with the user ID included in the received reservation request signal.

The completion of the above processes is equivalent to the followers' finishing making a reservation for participation in the private tarot fortune-telling broadcast.

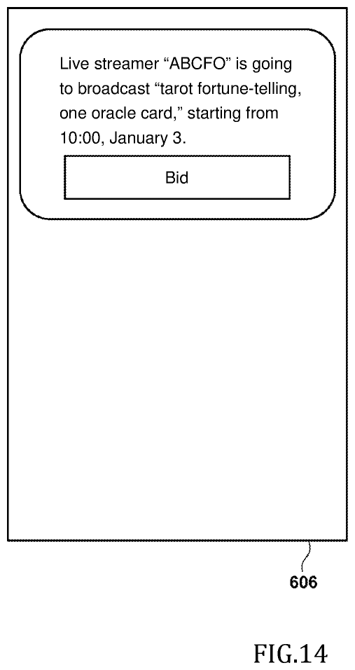

FIG. 14 is a schematic view of a broadcast schedule notification frame 606 typically displayed on the screens of the followers' user terminals 30 in step S504 of FIG. 11. The broadcast schedule notification frame 606 of FIG. 14 relates to the situation where the live streamer selects “notify followers” and selects “bidding” before clicking on the enter button in the broadcast schedule entering frame 600 of FIG. 12. The aforesaid situation is different from the situation of FIG. 13 in that the aforesaid situation entails holding bidding in order to aim at reservations for private tarot fortune-telling broadcasts. Means for holding bidding are disclosed in prior art and thus are not described herein for the sake of brevity. After the bidding, a follower who made the winning bid is regarded as the identified viewer and thus regarded as having finished making a reservation for the private tarot fortune-telling broadcast, thereby allowing the processes illustrated by FIG. 13 to take place subsequently.

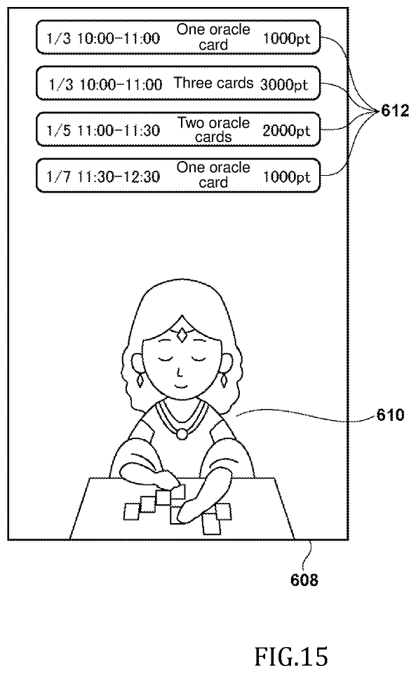

FIG. 15 is a schematic view of a live streaming frame 608 typically displayed on the screen of a viewer's user terminal 30. The live streaming frame 608 has an image 610 and a plurality of gift icons 612. The image 610 is taken of the live streamer and attained by playing the video data received by the server 10. The plurality of gift icons 612 are indicative of schedule gifts, respectively. When the playing of the video data starts (i.e., when the viewers begin to watch the live stream), the transmitting portion 304 of the server 10 refers to the gift database 320 to identify available gift ID. Regarding the schedule gifts, the transmitting portion 304 refers to the schedule database 316 to identify a private tarot fortune-telling broadcast schedule, whenever the private tarot fortune-telling broadcast schedule is the one which not only do the viewers want to watch immediately, but the live streamer also entered and rendered reservable. The transmitting portion 304 refers to the gift database 320 to identify the gift ID corresponding to the private tarot fortune-telling broadcast schedule identified, such that the identified gift ID serves as an available gift ID. The transmitting portion 304 generates a gift information including the identified gift ID and sends the gift information to the user terminals 30. The gift information associates the gift ID corresponding to the private tarot fortune-telling broadcasting schedule with the start date and time, the end date and time, the tarot type, and the value corresponding to the points granted. The superimposed information generating portion 204 of the user terminals 30 enables the frame image to include the gift icons 612 of the schedule gift. The schedule gift is identified with a gift ID included in the gift information. The gift icons 612 indicate verbally the consideration, tarot type, termination date and time, and commencement date and time of the private tarot fortune-telling broadcast schedule corresponding to a corresponding schedule gift. The viewing end UI control portion 202 displays a dynamic image superimposed on the frame image on the screen.

During a live stream, the live streamer urges the viewers to buy schedule gifts corresponding to the gift icons 612. If the viewing end UI control portion 202 receives the schedule gifts selected by the viewers, i.e., the identified gift icons 612, the input information transmitting portion 206 will generate an item-identifying signal including the gift ID of the selected schedule gift, the viewer ID, and the live streamer ID and send the item-identifying signal to the server 10 via the network NW. The processes in the server 10 after the receipt of the item-identifying signal are described above. The gift processing portion 308 updates the user database 318 by following the live streamer identified with the live streamer ID included in the item-identifying signal with a viewer identified with a viewer ID included in the received item-identifying signal. Thus, the disclosure provides mechanisms as follows: the viewers make a reservation for the live streamer's private tarot fortune-telling broadcast and thus automatically become the live streamer's followers; alternatively, viewers cannot participate in the live streamer's private tarot fortune-telling broadcast, unless the viewers are the live streamer's followers. Therefore, the users follow each other easily and more likely, and thus the live stream platform is busy. Furthermore, the subscription to the army disclosed in non-patent document 2 can be a substitute for the follow or an alternative to the follow.

Therefore, the user terminals 30 have the following functions: during a typical live stream which occurs before the private tarot fortune-telling broadcast begins, the instructions for use in making reservations for the private tarot fortune-telling broadcast and the promise (consideration) to make payment are received from the viewers, for example, by checking and clicking on the gift icons 612 to see whether they correspond to the received instructions.

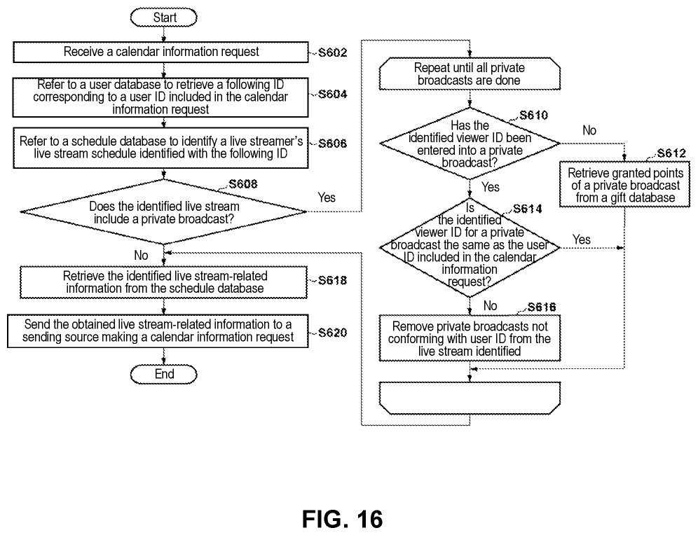

FIG. 16 is a flowchart of the process of creating calendar information in the server 10. The schedule managing portion 306 communicates with the user terminals 30 to receive from the user terminals 30 the calendar information request which requests the retrieval of the live stream schedule (S602). The schedule managing portion 306 refers to the user database 318 to retrieve the following ID corresponding to the request-making user's user ID included in the received calendar information request (S604). The schedule managing portion 306 refers to the schedule database 316 to identify the live stream schedule entered by the live streamer identified with the obtained following ID (S606). The identified live stream schedule comprises the situation of the private tarot fortune-telling broadcast schedule (“yes” to the question asked in S608). Before all the private tarot fortune-telling broadcast schedules have been processed, the schedule managing portion 306 repeats the processes defined in steps S610, S612, S614, and S616 described below.

The schedule managing portion 306 refers to the schedule database 316 to determine whether the identified viewer ID has been entered into the private tarot fortune-telling broadcast schedule (S610). If the determination is in the negative (when the answer to the question asked in S610 is “no”), the schedule managing portion 306 will retrieve the granted points corresponding to the private tarot fortune-telling broadcast schedule from the gift database 320 (S612). Then, the process flow returns to step S610. If the determination is in the affirmative (when the answer to the question asked in S610 is “yes”), the schedule managing portion 306 will determine whether the entered identified viewer ID is the same as the request-making user's user ID included in the calendar information request (S614). If the determination in S614 is in the affirmative (when the answer to the question asked in S614 is “yes”), no actions will be taken, allowing the process flow to return to step S610. If the determination in S614 is in the negative (when the answer to the question asked in S614 is “no”), the schedule managing portion 306 will remove non-conforming private tarot fortune-telling broadcast schedules from the live stream schedule identified in step S606 (S616). After that, the process flow returns to step S610.

After confirming the “no” scenario in step S608 or upon determination that all the private tarot fortune-telling broadcast schedules have been processed, the schedule managing portion 306 retrieves from the schedule database 316 informations about the identified live stream schedule (S618). The retrieved informations fall into categories as follows: (1) an information about a non-private live stream schedule entered by the live streamer whom the request-making user follows; (2) an information about the private tarot fortune-telling broadcast schedule reserved by a user in the private tarot fortune-telling broadcast schedule entered by the live streamer whom the request-making user follows; and (3) the granted points and information of reservable ones of the private tarot fortune-telling broadcast schedules entered by the live streamer whom the request-making user follows.

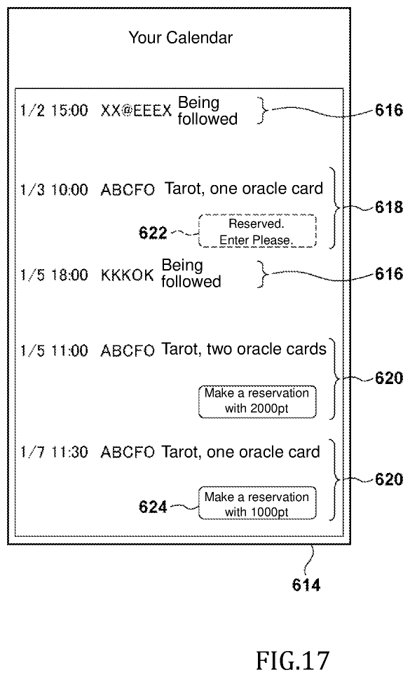

The schedule managing portion 306 sends the information about the live stream schedule, as obtained in step S618, to the user terminals 30 making a calendar information sending request (S620). FIG. 17 is a schematic view of a calendar display frame 614 typically displayed on the screen of a user terminal 30 which requests sending calendar information. The calendar display frame 614 has a schedule item 616 corresponding to the aforesaid category (1), a schedule item 618 corresponding to the aforesaid category (2), and a schedule item 620 corresponding to the aforesaid category (3). The schedule item 618 corresponding to the aforesaid category (2) has a button 622 which displays words indicative of the reserved schedules. The button 622 is disabled before the commencement of the live stream of the schedule but is enabled as soon as the live stream begins. Users click on the button 622 to join a live stream being broadcasted. The schedule item 620 corresponding to the aforesaid category (3) displays the commencement date and time, live streamer, type of tarot fortune-telling, and points required for a reservation of the private tarot fortune-telling broadcast. The schedule item 620 also has a button 624 for receiving from users the instructions for use in making reservations for the private tarot fortune-telling broadcast and the promise (consideration) to make payment. If users click on the button 624, the user terminals 30 generate a reservation request signal including a user's user ID and send the reservation request signal to the server 10 via the network NW. Subsequent processes illustrated by FIG. 13 occur.

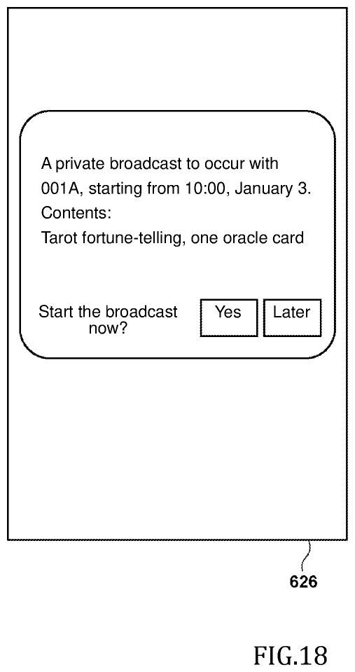

FIG. 18 is a schematic view of a broadcast reminder frame 626 typically displayed on the screen of the live streamer's user terminal 20 in step S506 illustrated by FIG. 11. The broadcast reminder frame 626 has commencement date and time, identified viewer ID, tarot type, yes button, and later button of the private tarot fortune-telling broadcast schedule of a reminded subject. If the live streamer clicks on the yes button, the broadcast of the private tarot fortune-telling will begin. Alternatively, the live streamer starts the broadcast of the private tarot fortune-telling without the broadcast reminder frame 626.

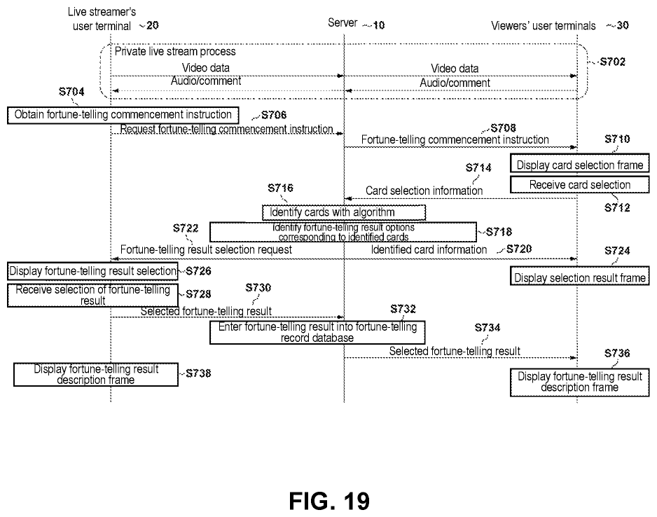

FIG. 19 is a flowchart of the process of the private tarot fortune-telling broadcast. During the private tarot fortune-telling broadcast, the video data is transmitted from the live streamer's user terminal 20 to the viewers' user terminals 30 via the server 10. The messages/audios inputted by the viewers are transmitted from the viewers' user terminals 30 to the live streamer's user terminal 20 via the server 10. These processes are collectively referred to as the private live stream process S702.

The broadcast end UI control portion 108 of the live streamer's user terminal 20 receives an instruction on starting fortune-telling from the live streamer (S704). If the broadcast end UI control portion 108 of the user terminal 20 of the live streamer receives an instruction on starting fortune-telling, the broadcast end UI control portion 108 will generate a fortune-telling commencement request and send the fortune-telling commencement request to the server 10 via the network NW (S706). If the tarot processing portion 312 of the server 10 receives the fortune-telling commencement request, the tarot processing portion 312 will generate a fortune-telling commencement instruction and send the fortune-telling commencement instruction to the viewers' user terminals 30 via the network NW (S708).

If the viewing end UI control portion 202 of the viewers' user terminals 30 receives a fortune-telling commencement instruction, the screens will display a card selection frame (S710). Thus, when the viewing end UI control portion 202 receives an instruction from the live streamer at the live stream, the card selection frame is displayed. The card selection frame has multiple card items related to tarot fortune-telling. The viewing end UI control portion 202 receives one card item, wherein the card item is one of the card items displayed in the card selection frame and is selected by a viewer (S712). The input information transmitting portion 206 of the viewers' user terminals 30 generates a card selection information including a selection card identification information for identifying a card item selected in step S712 and sends the card selection information to the server 10 via the network NW (S714).

The tarot processing portion 312 of the server 10 processes the selection card identification information included in the received card selection information with an established algorithm, so as to identify a tarot card presented to the live streamer and viewers (S716). The tarot processing portion 312 refers to the customization database 322 to thereby identify an option for the fortune-telling result corresponding to the selected tarot card (S718). The tarot processing portion 312 generates an identified card information included in the card ID of the tarot card identified in step S716 and sends the card information to the viewers' user terminals 30 via the network NW (S720). The tarot processing portion 312 generates a fortune-telling result selection request including “the card ID of the tarot card identified in step S716” and “the option identified in step S718” and sends the fortune-telling result selection request to the live streamer's user terminal 20 via the network NW (S722).

The viewing end UI control portion 202 of the viewers' user terminals 30 displays on the screens a selection result frame including “the tarot card identified by the card ID included in the received identified card information” (S724).

The broadcast end UI control portion 108 of the live streamer's user terminal 20 displays on the screen a fortune-telling result selection frame including “a tarot card identified with a card ID included in the received fortune-telling result selection request” and “an option included in the request” (S726). The broadcast end UI control portion 108 receives one option of a fortune-telling result, wherein the option of the fortune-telling result is one of the options of the fortune-telling result displayed in a fortune-telling result selection frame and is selected by the live streamer (S728). The broadcast end UI control portion 108 generates a fortune-telling result reply including the selected fortune-telling result and sends the fortune-telling result reply to the server 10 via the network NW (S730). The tarot processing portion 312 of the server 10 enters the selected fortune-telling result included in the received fortune-telling result reply into the fortune-telling record database 324 (S732). The tarot processing portion 312 sends the received fortune-telling result reply to the viewers' user terminals 30 (S734).

The viewing end UI control portion 202 of the viewers' user terminals 30 displays a fortune-telling result description frame including “the selected fortune-telling result included in the received fortune-telling result reply” on the screens (S736). Thus, during the private tarot fortune-telling broadcast, the viewers' user terminals 30 obtain the fortune-telling result selected by the live streamer presented with tarot cards corresponding to the card items selected in step S712 and provide the obtained fortune-telling result to the viewers. A frame identical to the fortune-telling result description frame presented to the viewers is also displayed on the screen of the live streamer's user terminal 20 (S738). The aforesaid process pertaining to fortune-telling and the private live stream process S702 take place simultaneously.

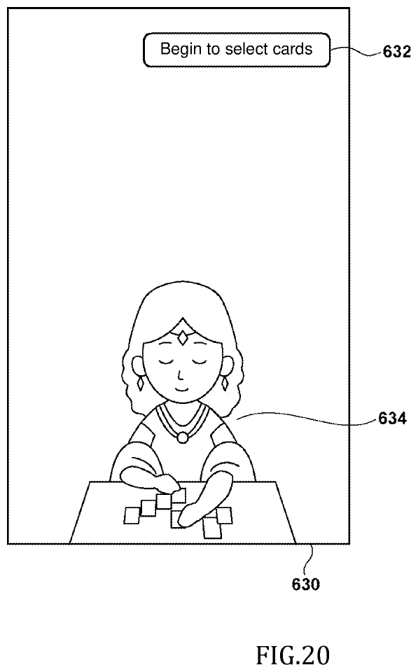

FIG. 20 is a schematic view of a broadcast end live streaming frame 630 typically displayed on the screen of the live streamer's user terminal 20 in step S704 of FIG. 19. The broadcast end live streaming frame 630 has an image 634 of the live streamer and a button 632 for starting to select cards. If the broadcast of the private tarot fortune-telling starts, the broadcast end live streaming frame 630 will be visible to the live streamer, and a viewing end live streaming frame for removing the button 632 from the broadcast end live streaming frame 630 will be visible to the viewers. The live streamer serving as a fortune-teller holds a dialogue with the viewers to obtain the viewers' related information. In the subsequent fortune-telling result selection and description, the live streamer can make use of the information obtained herein. The live streamer clicks on the button 632 of the broadcast end live streaming frame 630 at any appropriate time, so as to give a fortune-telling commencement instruction. If the live streamer's user terminal 20 detects the click, the live streamer's user terminal 20 will generate a fortune-telling commencement request and send the fortune-telling commencement request to the server 10.

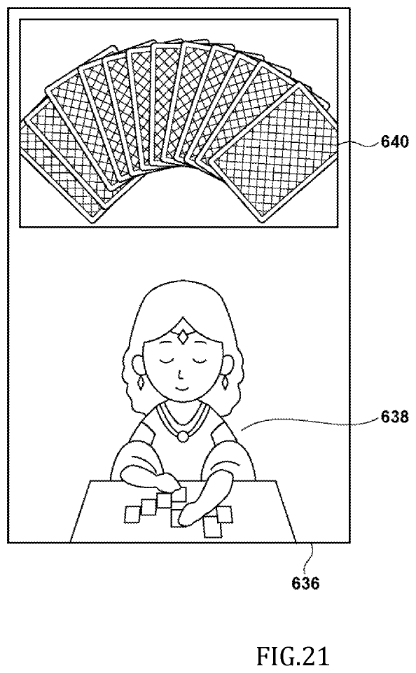

FIG. 21 is a schematic view of a card selection frame 636 typically displayed on the screens of the viewer user terminals 30 in step S710 of FIG. 19. The card selection frame 636 has an image 638 of the live streamer and a downward-facing card item group 640. The image 638 of the live streamer is obtained by playing the video data received from the server 10. The downward-facing card item group 640 simulates the downward-facing tarot cards arranged side by side. The downward-facing card items are distinguished from each other by a downward-facing card ID. During the live stream, the live streamer asks the viewer to select a downward-facing card item, and the viewer selects, by clicking on, a downward-facing card item from the downward-facing card item group 640. The viewers' user terminals 30 generate the card selection information including the downward-facing card ID of the downward-facing card items which are clicked on and send the card selection information to the server 10 via the network NW.

The tarot processing portion 312 identifies, by any one of the means described below, tarot cards presented to the viewers and the live streamer.

(1) Completely Random

The tarot processing portion 312 randomly identifies a tarot card without referring to the downward-facing card ID included in the received card selection information. In this situation, the viewer selects the downward-facing card items to trigger a random algorithm for selecting tarot cards.

(2) Determine in Advance

Before sending the fortune-telling commencement instruction, the tarot processing portion 312 determines the tarot card corresponding to the downward-facing card ID and records it in an established storage portion (not shown) in advance. The tarot processing portion 312 refers to the established storage portion to identify the tarot card corresponding to the downward-facing card ID included in the received card selection information.

(3) Random Algorithm Corresponding to Selecting Cards The tarot processing portion 312 identifies tarot cards with a random selection algorithm. The random selection algorithm treats the downward-facing card ID included in the received card selection information as a seed value.

Regardless of the means to use, all the tarot cards identified with the tarot processing portion 312 correspond to the downward-facing card items selected by the viewers.

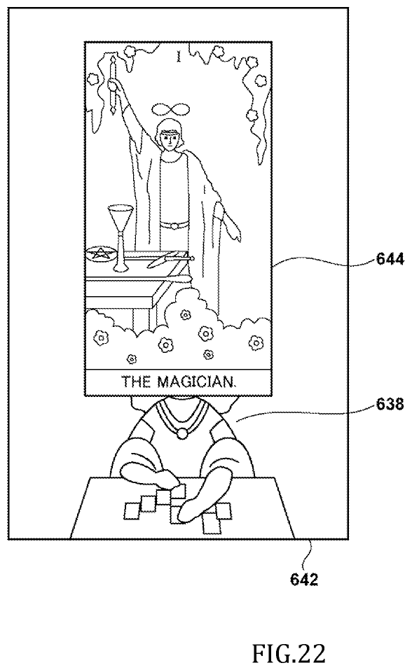

FIG. 22 is a schematic view of a selection result frame 642 typically displayed on the screens of the viewer user terminals 30 in step S724 of FIG. 19. The selection result frame 642 has an image 638 of the live streamer and a tarot card image 644 identified with a card ID included in the identified card information received from the server 10. During the time period in which the frame is displayed on the screens of the viewers' user terminals 30, the screen of the live streamer's user terminal 20 displays a fortune-telling result selection frame.

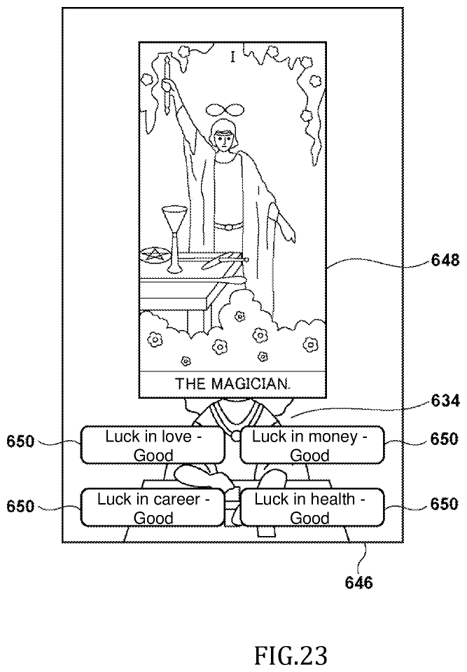

FIG. 23 is a schematic view of a fortune-telling result selection frame 646 typically displayed on the screen of the live streamer's user terminal 20 in step S726 illustrated by FIG. 19. The fortune-telling result selection frame 646 has an image 634 of the live streamer, a tarot card image 648 identified with a card ID included in the fortune-telling result selection request received from the server 10, and options 650 of the fortune-telling result included in the request. The live streamer selects, by clicking on, a fortune-telling result from the options 650 while watching the tarot card image 648 presented. The live streamer's user terminal 20 generates a fortune-telling result reply including the clicked options and sends the fortune-telling result reply to the server 10 via the network NW.

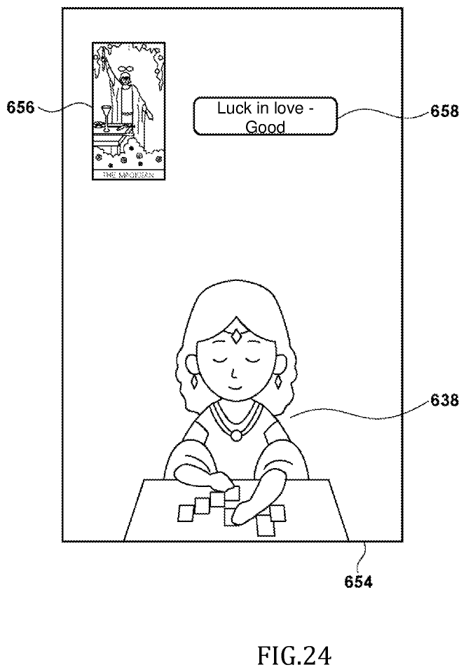

FIG. 24 is a schematic view of a fortune-telling result description frame 654 typically displayed on the screens of the viewer user terminals 30 in step S736 of FIG. 19. The fortune-telling result description frame 654 has an image 638 of the live streamer, a tarot card image 656 identified with the card ID included in the identified card information received from the server 10, and a fortune-telling result 658 selected by the live streamer and included in the fortune-telling result reply received by the server 10. During the time period in which the fortune-telling result description frame 654 is displayed to the viewers, the live streamer performing the live stream comments on the meaning of a tarot card drawn in the current instance and explains the reason for giving the fortune-telling result 658. If the viewer has doubts about the fortune-telling result 658 or objects thereto, the viewer may instantly leave a message to question the live streamer and receive a reply therefrom. Thus, during the private tarot fortune-telling broadcast, not only are fortune-telling results presented, but dialogues between the live streamer and the viewer on the fortune-telling result are also facilitated, thereby further enhancing the live streamer's and the viewer's satisfaction.

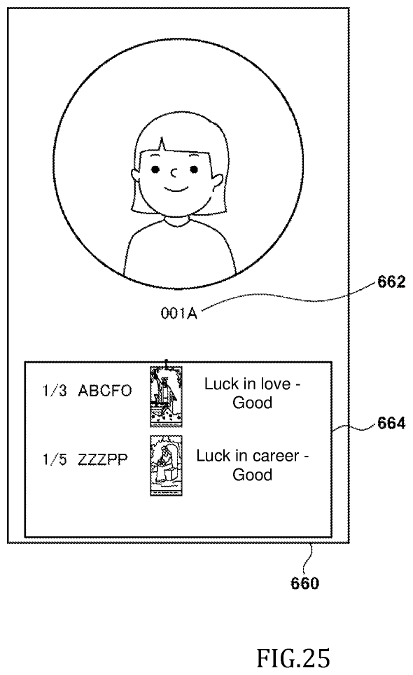

FIG. 25 is a schematic view of a fortune-telling record frame 660 typically displayed on the screens of the viewers' user terminals 30 in step S510 of FIG. 11. The fortune-telling record frame 660 has the viewers' user ID 662 and a fortune-telling record display region 664 for displaying the fortune-telling results of the viewers' past participation in the private tarot fortune-telling broadcast. The fortune-telling record display region 664 displays the dates of private tarot fortune-telling broadcasts which the viewers previously participated in as well as the live streamer ID, tarot card images, and fortune-telling results selected by the live streamer at the private tarot fortune-telling broadcasts.

If the viewing end UI control portion 202 of the viewers' user terminals 30 receives a record display instruction from the viewer, the viewing end UI control portion 202 will generate a record retrieval request including the viewers' user ID and send it to the server 10 via the network NW. The tarot processing portion 312 of the server 10 retrieves from the fortune-telling record database 324 past fortune-telling results of users identified with the user ID included in the record retrieval request received. In an example illustrated by FIG. 10, when the record retrieval request comprises user ID “001A,” the tarot processing portion 312 retrieves a record of the fortune-telling result, which comprises the following remarks “commencement date and time=1/3, 10:00; the live streamer ID=ABCFO; tarot type=one oracle card; fortune-telling result=card ID:XX, good luck in love” and “commencement date and time=1/5, 12:00; the live streamer ID=ZZZPP; tarot type=one oracle card; fortune-telling result=card ID:YY, good luck in career.” The tarot processing portion 312 generates a reply information including the fortune-telling result record obtained and sends the reply information to the user terminals 30 which request sending the record retrieval request via the network NW. The viewing end UI control portion 202 of the user terminals 30 turns the received reply information into contents displayed in the fortune-telling record display region 664 and displays the fortune-telling record frame 660 having the fortune-telling record display region 664 on the screens.

In the aforesaid embodiment, the storage portion is, for example, a hard disk drive or a semiconductor memory. After referring to this document, persons skilled in the art understand that the disclosure can be implemented by a CPU (not shown), APP modules installed, modules of system programs, and semiconductor memory for temporarily storing data read from a hard disk drive.

In the live streaming system 1 provided according to this embodiment, a tarot fortune-telling live stream begins with the viewers selecting downward-facing card items. Then, the tarot cards corresponding to the selected downward-facing card items are presented to the live streamer, and the live streamer chooses the results of fortune-telling. Thus, a chosen fortune-telling result is displayed to both the live streamer and each viewer during a tarot fortune-telling live stream. During the live stream, the live streamer explains the reason for giving a fortune-telling result or gives supplementary comments, whereas, in response to this, the related viewer may ask questions instantly. Therefore, the disclosure provides a mechanism whereby a live streamer performs a tarot fortune-telling live stream smoothly and effectively with a view to promoting tarot fortune-telling live streaming and thereby popularizing it.

In addition to this embodiment, the tarot fortune-telling live streaming can be implemented in variant embodiments characterized by: (1) the live streamer manipulates his or her physical tarot cards at hand and live streams the manipulation process; and (2) the viewer draws a card and presents its result automatically and uniformly, in the same way as playing tarot fortune-telling games. In the tarot fortune-telling live stream in this embodiment, the tarot cards are identified according to the viewers' direct reactions. Thus, compared with characteristic (1), this embodiment enhances the viewers' actual experience in participation in live streams. In the tarot fortune-telling live stream in this embodiment, the fortune-telling results presented by the live streamer are recorded at the live streamer input terminal in the form of data and presented to the viewers simultaneously. Thereafter, the viewers can peruse the records of the fortune-telling results, and thus user convenience increases compared with characteristic (1). During a tarot fortune-telling live stream in this embodiment, the live streamer selects from the options of the fortune-telling results an option suitable for the current instance of fortune-telling and displays the option to a viewer whenever the viewer selects a downward-facing card item and displays a tarot card corresponding to the selected downward-facing card item. When two viewers draw the same tarot card, it is possible for the fortune-telling result presented to one of the viewers to be different from the fortune-telling result presented to the other viewer. It is also possible that the fortune-telling result presented to a viewer having drawn a tarot card during a live streamer's tarot fortune-telling live stream is different from the fortune-telling result presented to the same viewer having drawn the same tarot card during another tarot fortune-telling live stream of the same live streamer. In this embodiment, during the tarot fortune-telling live stream, the fortune-telling results are adjusted to better suit the viewers' fortune-telling results according to the contents of dialogues between the live streamer serving as a fortune-teller and each viewer, fortune-telling timing, and the live streamer's experience and inspiration. Thus, compared with the games aspect of characteristic (2), unlike the situation where identical fortune-telling results normally arise from identical tarot cards, not only are the live streamer fortune-telling results rendered flexible to enhance fortune-telling quality, but the viewers can also receive customized fortune-telling service which are more suitable for self-use to thereby enhance user satisfaction.

The live streaming system 1 in this embodiment requests the live streamer to input fortune-telling results and record the inputted fortune-telling results, thereby allowing the viewers to peruse the records of the fortune-telling results. Thus, the viewers who participate in a tarot fortune-telling live stream but forget its fortune-telling results may peruse the records to thereby recall the fortune-telling results, thereby enhancing user convenience.

The live streaming system 1 in this embodiment comprises a customization database 322 to not only allow each live streamer to customize tarot fortune-telling contents but also allow each live streamer to easily differentiate his or her tarot fortune-telling from the other live streamers' tarot fortune-telling. From a platform perspective, all kinds of tarot fortune-telling live streams are held irrespective of their contents, so as to enrich the contents of tarot fortune-telling.

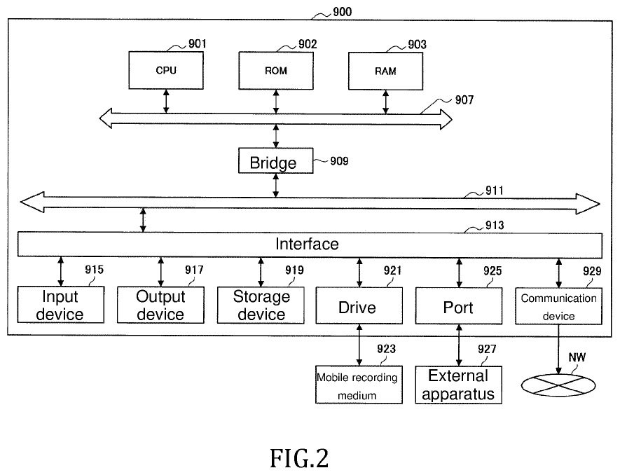

FIG. 2 illustrates the hardware framework of an information processing device according to an embodiment of the disclosure. FIG. 2 is a block diagram of an information processing device according to an embodiment of the disclosure. As shown in the diagram, an information processing device 900, for example, functions as the server 10 and user terminals 20, 30 in this embodiment.

The information processing device 900 comprises a CPU 901, ROM (read-only memory) 903 and RAM (random access memory) 905. Alternatively, the information processing device 900 comprises a main bus 907, bridge 909, external bus 911, interface 913, input device 915, output device 917, storage device 919, drive 921, port 925, and communication device 929. The information processing device 900 comprises a picture-taking device (not shown), such as a camera. In the information processing device 900, a processing circuit substitutes for the CPU 901 and has a DSP (Digital Signal Processor) or ASIC (Application Specific Integrated Circuit).

The CPU 901 functions as an algorithmic processing device and a control device and controls all or part of the operations within the information processing device 900, using various programs stored in the ROM 903, RAM 905, storage device 919 or mobile recording medium 923. For example, the CPU 901 controls all the operations of functional portions included in the server 10 and user terminals 20, 30 of this embodiment, respectively. The ROM 903 stores therein the programs and algorithmic parameters for use by the CPU 901. The RAM 905 temporarily stores programs for use by the operating CPU 901 and parameters varying appropriately during the operation of the CPU 901. The CPU 901, ROM 903 and RAM 905 are interconnected by the main bus 907 comprising internal buses, such as CPU buses. The main bus 907 is connected by the bridge 909 to the external bus 911, such as PCI (Peripheral Component Interconnect/Interface) bus.

The input device 915 is, for example, a user-operated device, such as a mouse, keyboard, touch panel, button, switch and operating lever. Alternatively, the input device 915 is, for example, a device capable of converting physical quantity into electrical signals, such as a voice sensor (for example, a microphone), acceleration sensor, tilt sensor, infrared sensor, depth sensor, temperature sensor, and humidity sensor. Alternatively, the input device 915 is, for example, a remote control device operating by infrared or any other electromagnetic waves. Alternatively, the input device 915 is, for example, an external apparatus 927, such as a mobile phone corresponding in operation to the information processing device 900. The input device 915 comprises an input control circuit which generates input signals according to information inputted by users or physical quantity sensed and inputs the input signals to the CPU 901. The users operate the input device 915 to thereby input various data to the information processing device 900 or instruct the information processing device 900 to operate.

The output device 917 notifies, visually or acoustically, users of retrieved information. The output device 917 is, for example, a printer device, an audio output device (such as loudspeaker and earpiece), or a screen (such as LCD, PDP, and OELD). The output device 917 outputs the results of the processing operations performed by the information processing device 900 in the form of videos (comprising text or images) or voices (comprising audios).

The storage device 919 stores data and is, for exemplary purposes, a storage portion of the information processing device 900. The storage device 919 is, for example, a magnetic storage device (such as hard disk drive, HDD), semiconductor storage device, optical storage device or photomagnetic storage device. The storage device 919 stores therein various data and programs executable by the CPU 901, and externally-derived various data.

The drive 921 is a reader/writer for the mobile recording medium 923, such as a floppy disk, compact disk, floptical disk or semiconductor memory. The drive 921 is built-in with or externally connected to the information processing device 900. The drive 921 reads information recorded in the mobile recording medium 923 installed and outputs the information to the RAM 905. The drive 921 writes the records to the mobile recording medium 923 installed.

The port 925 connects an apparatus to the information processing device 900 directly. The port 925 is, for example, USB (Universal Serial Bus) port, IEEE1394 port, and SCSI (Small Computer System Interface) port. The port 925 may also be RS-232C port, acousto-optic terminal, or HDMI (High-Definition Multimedia Interface) port. With the external apparatus 927 being connected to the port 925, various data can be transmitted between the information processing device 900 and the external apparatus 927.

The communication device 929 is, for example, a communication interface which comprises communication components adapted to be connected to the network NW. The communication device 929 is, for example, a communication card for use in wired or wireless LAN (Local Area Network), Bluetooth, or WUSB (Wireless USB). The communication device 929 is a router for use in optical communication, router for use in ADSL (Asymmetric Digital Subscriber Line), or modem for use in various communication. The communication device 929, for example, receives and transmits signals on the Internet or between the other communication apparatuses by an existing protocol, such as TCP/IP. The communication network NW is connected to the communication device 929 wiredly or wirelessly, for example, via the Internet, family-oriented LAN, infrared communication, radio-wave communication or satellite communication. The communication device 929 functions as a communication portion.

A picture-taking device (not shown), such as a camera, is, for example, CCD (Charge Coupled Device) or CMOS (Complementary Metal Oxide Semiconductor), and uses various components, such as lenses, for controlling the imaging of a subject by a picture-taking component and thereby taking pictures of actual space, so as to generate images. The picture-taking device can take pictures or shoot videos.

The structure and operation of the live streaming system 1 in this embodiment are described above. This embodiment serves exemplary purposes. Persons skilled in the art understand that the combination of constituent elements and the combination of processes can be implemented in variant embodiments, and the variant embodiments shall be deemed falling within the scope of the disclosure.

The aforesaid embodiment illustrates examples of the private tarot fortune-telling broadcast, but the disclosure is not limited thereto. For instance, the technical concepts embodied in the aforesaid embodiment may also apply to a tarot fortune-telling broadcast which multiple viewers participate in, or to a tarot fortune-telling broadcast in which both the participation of a live streamer and identified viewers and the participation of the other viewers are permitted (i.e., permitting any viewers other than the viewers who made reservations for participation in the tarot fortune-telling broadcast to participate in the tarot fortune-telling broadcast). During a tarot fortune-telling broadcast which the identified viewers are participating in, any other viewers may watch the ongoing tarot fortune-telling broadcast as if they were visitors. The broadcast schedule entering frame 600 shown in FIG. 12 may be further provided with an option “Set to a private broadcast or not?”, thereby allowing the live streamer to determine whether to set the tarot fortune-telling broadcast to be private.

In this situation, the live streamer expects a large number of viewers to see the propaganda efficacy achieved by the live streamer in terms of fortune-telling and anticipates new clients. Furthermore, a viewer can evaluate the extent of the other identified viewers' acceptance of the fortune-telling service provided by the live streamer to thereby facilitate his or her selection of live streamers offering fortune-telling service.

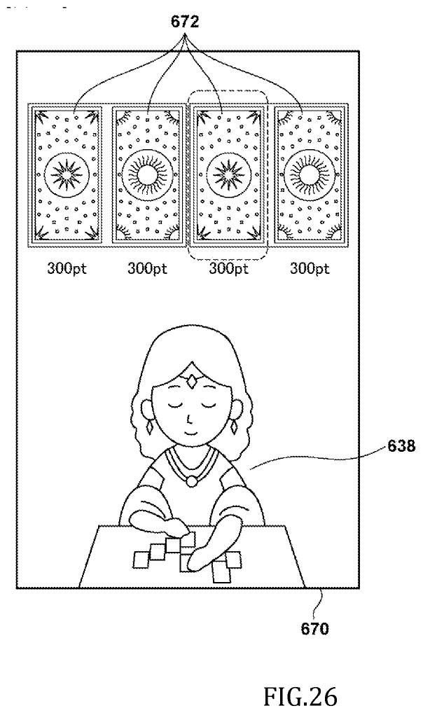

Alternatively, the disclosure provides a tarot fortune-telling broadcast which is open to all viewers. FIG. 26 is a schematic view of a card selection frame 670 typically displayed on the screens of the viewer user terminals 30 during an all-viewers tarot fortune-telling broadcast according to a variant embodiment of the disclosure. The card selection frame 670 has the live streamer image 638 and four card items 672. The live streamer image 638 is attained by playing the video data received from the server 10. The four card items 672 simulate four tarot cards facing downward. During the live stream, the live streamer asks multiple viewers to choose their desired downward-facing card items, respectively. The viewers each click and choose one of the four downward-facing card items 672. In the example illustrated by FIG. 26, out of the four downward-facing card items 672, the second one from the right is selected, with the selected downward-facing card item 672 being surrounded by a dashed line indicative of the selection.

In this example, payment must be made before the selection of the downward-facing card items 672 is permitted. In the example illustrated by FIG. 26, the amount of payment, i.e., 300 pt, is shown under each of the downward-facing card items. If the viewers' user terminals 30 detect a click on the downward-facing card items 672, the viewers' user terminals 30 will identify the downward-facing card ID of the downward-facing card items 672 and accept the promise (consideration) to make payment.

If the number of users selecting the downward-facing card items 672 reaches a predetermined number or a certain time period has elapsed, the server 10 will perform the process of selecting one of the four downward-facing card items 672. The process involves, for example, receiving one downward-facing card item 672 from the live streamer at the live streamer's user terminal 20 or selecting one downward-facing card item 672 (for example, selecting the downward-facing card item 672 most favored by viewers) according to the number of the viewers selecting each downward-facing card item 672. Accordingly, the server 10 identifies the tarot card corresponding to the downward-facing card ID of the selected downward-facing card item 672. The matching relationship between the downward-facing card ID and (the card ID of) the tarot card is predefined by the live streamer or automatically defined and entered into an established storage portion. When the downward-facing card items 672 selected by the viewers are consistent with the downward-facing card items 672 selected by the server 10, processes which are the same as the processes illustrated by FIG. 22, FIG. 23, and FIG. 24 are performed on the viewers. In case of inconsistency, the server 10 retrieves from the customization database 322 the remark corresponding to the card ID of the tarot card corresponding to the downward-facing card items 672 selected by the viewers. The server 10 generates a notification information including “the card ID of the tarot card corresponding to the downward-facing card items 672 selected by the server 10,” “the card ID of the tarot card corresponding to the downward-facing card items 672 selected by the viewers,” and “the remark retrieved” and sends the notification information to the viewers' user terminals 30 via the network NW.

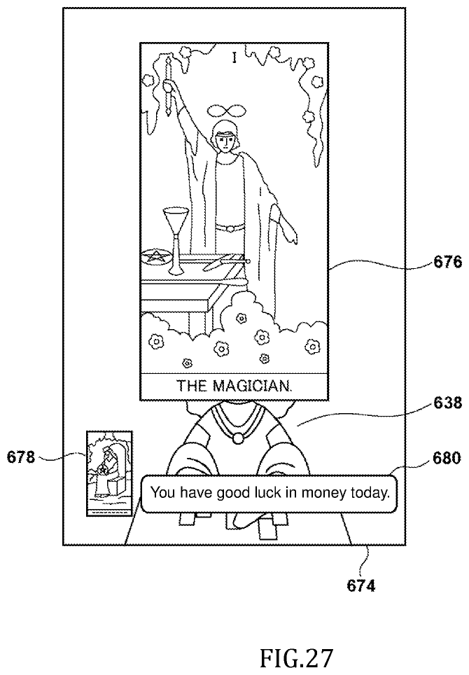

FIG. 27 is a schematic view of a fortune-telling result display frame 674 typically displayed on the screens of the viewers' user terminals 30. The fortune-telling result display frame 674 has the live streamer's image 638, a tarot card image 676 corresponding to a downward-facing card item 672 selected by the server 10, a tarot card image 678 corresponding to the downward-facing card item 672 selected by the viewer, and a remark 680 included in a notification information. Even if the downward-facing card item selected by the viewer is not chosen to be a fortune-telling subject, the viewer may still confirm his or her tarot card by watching the tarot card image 678 and further explore fortunes corresponding to his or her tarot card by watching the remark 680. In so doing, although the viewer's card item is not chosen, the viewer's frustration is mitigated.

The embodiment explains how to make pre-payment for making a reservation for watching a tarot fortune-telling broadcast, but the disclosure is not limited thereto. For example, a viewer makes payment in the form of a gift to the live streamer at any point in time during the tarot fortune-telling broadcast or when the selection side of a card item faces downward. Making payment before selecting the downward-facing card items entails providing only one selectable downward-facing card item, requiring the viewer to select one of downward-facing card items which vary in consideration, or requiring the viewer to make payment immediately before participating in the tarot fortune-telling broadcast.

The embodiment illustrates how to provide the fortune-telling record database 324 at the server 10, but the disclosure is not limited thereto. For instance, the viewers' user terminals 30 each comprise a fortune-telling record database for storing the viewers' past fortune-telling results.

In the embodiment illustrated by FIG. 15, the live streamer serving as a fortune-teller sells his or her private tarot fortune-telling broadcast schedule at his or her live stream, but the disclosure is not limited thereto. For example, a live streamer may sell at her or his live stream private tarot fortune-telling broadcast schedules which s/he believes to be of high quality or private tarot fortune-telling broadcast schedules of the other live streamers whom s/he follows. In so doing, the fortune-telling live streaming community thrives further.

In the embodiment, the followers are notified of private tarot fortune-telling broadcast schedules newly entered, whereas a viewer is registered as a follower of the live streamer as soon as the viewer uses a schedule gift during the live stream, i.e., a prerequisite for the follower's participation in the live streamer's private tarot fortune-telling broadcast. Thus, not only is the follower-following relationship enhanced, but the connection between users is also enhanced. However, the disclosure is not limited thereto. For example, viewers who do not follow the live streamer may also participate in the live streamer's private tarot fortune-telling broadcast.

This embodiment describes the situation where the live streamer presented with the tarot cards corresponding to the downward-facing card items selected by the viewers chooses one of fortune-telling result options; but the disclosure is not limited thereto. For example, the live streamer watches the displayed tarot cards and inputs fortune-telling results in the form of text at the user terminal 20. Alternatively, the live streamer narrates the fortune-telling results during the live stream, and the user terminal 20 capable of converting audios into text converts the live streamer's audios into text so as to input the fortune-telling results.

Although the tarot type is provided in this embodiment, fortune-telling topics may be provided to substitute for the tarot type or provided in addition to the tarot type. The fortune-telling topics are exemplified by luck in money, luck in love, luck in career, luck in health, etc. Options are entered one by one into the customization database 322 in accordance with the fortune-telling topics. The followers are notified of the newly entered private tarot fortune-telling broadcast schedule and the configured fortune-telling topics simultaneously.

In this embodiment, the conversion rate of the consideration for a gift to the granted points for the gift serves as an example and can be appropriately set, for example, by an administrator of the live streaming system 1.

The technical concepts embodied in the embodiments are applicable to live stream commerce or VR live streams in which a virtual stand-in whose movement synchronizes with the live streamer's movement substitutes for the live streamer's image.

A process procedure described herein, especially a process flow or a process procedure depicted with a flowchart, may be dispensed with a portion of steps which the process procedure consists of, supplemented with unspecified steps, and/or altered in terms of the sequence of the steps. The process procedure which has undergone the omission, supplementation, and/or sequence alteration without departing from the spirit of the disclosure shall be deemed falling within the scope of the disclosure.

At least a portion of the functions implemented by the server 10 can also be implemented by a device other than the server 10, for example, user terminals 20, 30. At least a portion of the functions implemented by the user terminals 20, 30 can also be implemented by a device other than the user terminals 20, 30, for example, the server 10. For example, superimposition of an existing frame image on top of an image of video data at a user terminal at a playing end can also occur at the server 10 or at a user terminal at the generating end.

What is claimed is:

1. A user terminal at a playing end for live streaming related video data comprising:
a screen;
one or more processors; and
memory storing one or more computer programs configured to be executed by the one or more processors, the one or more computer programs including instructions for:
receiving video data from a server via a network;
displaying a plurality of items on the screen of the user terminal at the playing end;
receiving designation of an item, with the item being one of the plurality of items and being selected by a user at the playing end; and
obtaining, during a live stream, a result entered by a user at a generating end, wherein the user enters the result after being presented with an information corresponding to the selected item.

2. The user terminal of claim 1, wherein the one or more computer programs includes instructions for displaying the result on the screen at the request of the user at the playing end, after completion of the live stream.

3. The user terminal of claim 1, wherein the one or more computer programs includes instructions for matching information corresponding to the selected item with the result obtained and displaying them on the screen, during the live stream.

4. The user terminal of claim 1, wherein the function of displaying a plurality of items includes starting to display a plurality of items in response to an instruction given by the user at the generating end during the live stream.

5. The user terminal of claim 1, wherein the one or more computer programs includes instructions for receiving from the user at the playing end an instruction on making a reservation for the live stream and a promise to make payment of consideration, before commencement of the live stream.

6. The user terminal of claim 5, wherein the live stream is configured in such a way to allow any users at the playing end, other than those having reserved the live stream, to participate in the live stream.

7. A user terminal at a generating end for live streaming related video data comprising:
a screen;
one or more processors; and
memory storing one or more computer programs configured to be executed by the one or more processors, the one or more computer programs including instructions for:
sending video data to a server via a network;
displaying on the screen of the user terminal at the generating end an information corresponding to an item, with the item being one of a plurality of items and being selected by a user at a playing end; and
receiving a result entered by a user at the generating end, wherein the user enters the result after being presented with the information.

8. The user terminal of claim 7, wherein the receiving function includes receiving designation of an option included in a plurality of options displayed on the screen and selected by the user at the generating end, wherein the plurality of options vary with the information.

9. The user terminal of claim 8, wherein the one or more computer programs includes instructions for setting, by the user at the generating end, an option corresponding to the information.

10. The user terminal of claim 7, wherein the one or more computer programs includes instructions for receiving, at the live stream, an instruction for instructing a user terminal at the playing end to start displaying a plurality of items.

11. The user terminal of claim 7, wherein the one or more computer programs includes instructions for receiving registration of a schedule of the live stream and a consideration, by the user at the generating end, before commencement of the live stream.

12. A server, comprising:
a means for transmitting the video data from a user terminal at a generating end for live streaming related video data to a user terminal at a playing end;
a means for receiving from the user terminal at the playing end a recognition information about an item, with the item being one of a plurality of items displayed on the screen of the user terminal at the playing end and being selected by a user at the playing end;
a means for identifying, according to the received recognition information, an information corresponding to the selected item;
a means for sending the selected information to the user terminal at the generating end;
a means for receiving, from the user terminal at the generating end, a result entered by a user at the generating end, wherein the user at the generating end enters the result after being presented with the selected information; and
a means for providing the received result to the user terminal at the playing end.
